(19) United States
(12) Patent Application Publication
(10) Pub. No.: US 2023/0304282 A1
(43) Pub. Date: Sep. 28, 2023

(54) CLASS 1 FLEXIBLE UNINSULATED DUCT WITH POLYMER CORE AND SURROUNDING FIRE RESISTANT BARRIER LAYER AND METHOD OF USE

(71) Applicant: FLEXIBLE TECHNOLOGIES, INC., Abbeville, SC (US)

(72) Inventor: Ronald L. CARLAY, II, Laurens, SC (US)

(21) Appl. No.: 18/125,264

(22) Filed: Mar. 23, 2023

Related U.S. Application Data
(60) Provisional application No. 63/323,937, filed on Mar. 25, 2022.

(51) Int. Cl. E04B 1/94; F24F 13/02; B32B 37/12; B32B 5/02

(52) U.S. Cl. CPC E04B 1/94; F24F 13/0218; B32B 37/12; B32B 5/022; B32B 5/024; B32B 2367/00; B32B 2315/085

(57) ABSTRACT

An uninsulated duct for use in interior spaces that do not require insulation includes a polymer core and a fire resistant barrier layer surrounding the polymer core. The fire resistant barrier layer is made of a material that makes the uninsulated duct one that meet the UL 181 Class 1 duct rating in terms of flame spread index and developed smoke. With the use of the fire resistant barrier layer, a polymer core, which is flammable, can be made part of the flexible uninsulated duct while still achieving the UL 181 Class 1 duct standard rating.

### FIELD OF THE INVENTION

The invention relates to uninsulated ducts that carry a UL 181 Class 1 duct rating, the uninsulated ducts designed primarily for use in interior wall and floor spaces where duct insulating properties are not need but flame spreading and smoke development resistance for the uninsulated ducts is required.

### BACKGROUND ART

The use of smaller diameter uninsulated ducts for interior spaces like floors and walls in a structure is well known. An example of such a duct is the S-TL duct sold by Flexible Technologies, see https://thermaflex.net/products/thermaflex-s-tl-flexible-duct/. This prior art duct uses a fiberglass cloth fabric bonded to a wire helix to provide its Class 1 duct rating.

Reference to a Class 1 duct rating refers to the UL 181 standard published Jul. 25, 2013 and entitled UL Standard for Safety Factory-Made Air Ducts and Connectors. This standard describes a Class 1 rating as air ducts and air connectors having a flame-spread index of not over 25 without evidence of continued progressive combustion and a smoke-developed index of not over 50. Hereinafter, this standard is abbreviated as the UL 181 Class 1 duct standard.

Although the prior art S-TL duct provides the desired Class 1 rating that permits its use in interior spaces, its manufacturing process is complicated and expensive.

Furthermore, the demand for these kinds of duct applications have grown due to the use of different modes of cooling and heating for interior spaces of structures, wherein ductwork is more often utilized in a conditioned space such that the ductwork is not in need of additional insulation. As such, a need exists to provide an alternative to the prior art duct mentioned above, the alternative duct being one that is more economically made and can better meet the increased demand for these kinds of ducts.

In response to this need, the inventive duct provides an improved design that facilitates its manufacture in a cost effective manner while at the same time still providing the Class 1 duct rating to allow its use in application where this rating is required, for example, as a replacement duct for the S-TL ductwork described above.

### SUMMARY OF THE INVENTION

The invention provides an improvement in flexible uninsulated ducts that meet the UL 181 Class 1 duct standard.

In one embodiment, the flexible uninsulated duct that meets Underwriter Laboratories (UL) 181 Class 1 duct standard has a polymer core that includes a helical wire as a part thereof, the polymer core forming an inner space for conditioned air flow, and having an outer surface. A fire resistant barrier layer is provided that surrounds the outer surface of the polymer core, the fire resistant barrier layer providing flame spreading and smoke development resistance such that the flexible uninsulated duct meets the UL 181 Class 1 duct standard. In the inventive duct construction, a first surface of the fire resistant barrier layer faces the outer surface of the polymer core and an outer surface of the fire resistant barrier layer is exposed to form an outer surface of the uninsulated duct.

While the polymer core can be any known polymer core typically used as part of a flexible duct construction, one example is a polymer core that uses a pair of PET layers with a helical wire positioned therebetween.

Since the inventive flexible insulated duct meets the UL 181 Class 1 duct standard, it can have a length greater than 14 feet so as not to be considered a connector that falls under this standard as such a connector does not meet all of the tests required for a duct falling under the UL 181 Class 1 duct standard.

While the fire resistant barrier layer can be associated with the polymer core in any known fashion to keep the two together to form the composite duct construction, one mode of association is adhering the fire resistant barrier layer to the outer surface of the polymer core using an adhesive. As an alternative association between the fire resistant barrier layer and the polymer core, the fire resistant barrier layer can have first and second opposing longitudinal edges, with the edges sewn or stitched together such that the fire resistant barrier layer surrounds the outer surface of the polymer core.

While the fire resistant barrier layer can be any type of material that, when surrounding the polymer core, the composite duct structure would meet the UL 181 Class 1 duct standard, a preferred material would be a woven or non-woven fabric material containing fiberglass. An alternative material would be a fire resistant fleece comprising fire resistant staple fibers and optionally char scaffold fibers.

The invention also entails the use of one or more of the flexible uninsulated duct for moving conditioned or unconditioned air therethrough in a given structure, wherein the one or more flexible uninsulated ducts is in an interior space of a structure, e.g., in floor or walls spaces of the structure, wherein further insulation for the inventive duct is not required.

### BRIEF DESCRIPTION OF THE DRAWINGS

FIG. 1 shows a cross sectional view of an embodiment of the inventive duct.

FIG. 2 shows an exemplary use of the inventive duct in a wall space.

FIG. 3 shows another embodiment of the inventive duct.

FIG. 4 shows a section of the fire resistant barrier layer of the inventive duct in connection with duct manufacture.

### DETAILED DESCRIPTION OF THE INVENTION

The uninsulated duct provides significant advantages over other and similar type ducts. Whereas the entire duct construction of the prior art duct S-TL is designed to meet the UL 181 Class 1 duct standard, the inventive uninsulated duct can be more economically made due to the ability to use what is essentially a stock polymer core and impart a Class 1 duct rating to the duct by associating the polymer core with an outer fire resistant barrier layer such that the polymer core-fire resistant duct construction meets the UL 181 Class 1 duct standard, wherein the duct would pass all of the 15 tests set forth in the UL 181 standard, as distinguished from the connector category for this particular standard.

The polymer core for use with the inventive duct is a typical helical wire-containing polymer core used as part of flexible ducts for conditioned or unconditioned air. Examples of these kinds of polymer cores are described in U.S. Pat. No. 10,767,892 to Campbell et al. and the other prior art disclosed therein. This patent is incorporated in its entirety herein, particularly with respect to its teachings regarding polymer cores for flexible ducts.

A typical polymer core construction includes two layers of a polymer material, e.g., polyolefin, polyester, polyvinyl chloride or mixtures thereof, with polyester terephthalate (PET) being a more preferred polymer, with a helical wire positioned therebetween. With the two polymer layers adhered to each other, the helical wire, which can be either metal or plastic as is known in the art, becomes an integral part of the flexible polymer core. The helical wire provides additional structure to the duct and allows for its compressibility and expansion. The core outer and/or inner surfaces can be metallized as is also well known in the art if a particular duct application requires such metallization.

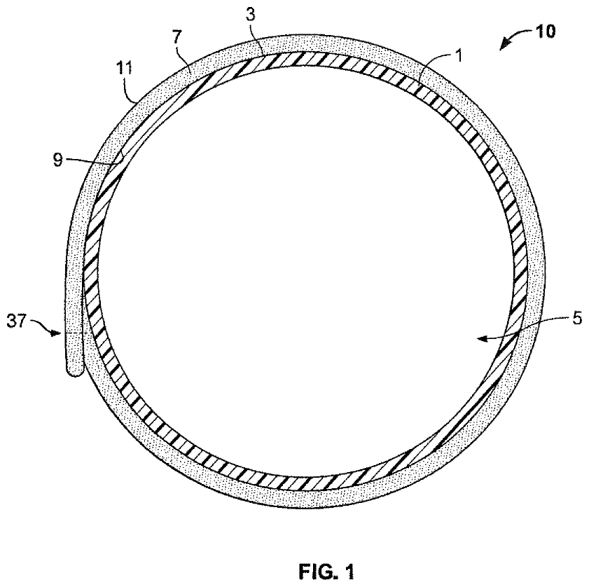

FIG. 1 shows a schematic and sectional view of one embodiment of the inventive flexible uninsulated duct. The inventive uninsulated duct is designated by the reference numeral 10. The polymer core is designated by the reference numeral 1. The helical wire that extends longitudinally through the polymer core is not illustrated in FIG. 1 for simplicity purposes. The polymer core 1 has an outer surface 3 and forms a passageway 5 that allows for conditioned air or the like to flow therethrough.

Surrounding the outer surface 3 of the polymer core is a fire resistant barrier layer 7. The inner surface 9 of the fire resistant barrier layer faces the outer surface 3 of the polymer core. The fire resistant barrier layer 7 includes an outer surface 11, which acts as an exposed surface of the uninsulated duct 10, meaning no other material covers the outer surface 11 of the fire resistant barrier layer. The fire resistant barrier layer 7 is depicted in FIG. 1 as a fibrous or felt-like material but the barrier layer is not limited to just these kinds of materials.

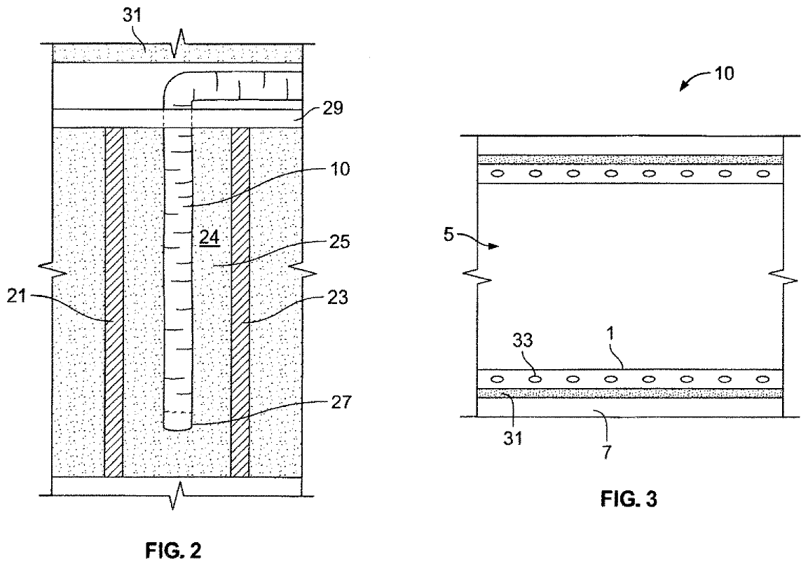

FIG. 2 shows a typical application of the inventive uninsulated duct wherein a schematic diagram of an internal wall portion with interior wall and floor spaces that can utilize the inventive duct is depicted. The diagram shows just one wall of the internal wall portion so that the inventive duct is readily seen in its application. The internal wall portion includes a pair of studs 21 and 23 that together with the walls on either side of the studs 21 and 23 (one wall depicted as 24) form a wall space 25. The inventive duct 10 is shown positioned inside the wall space 25, with a termination 27 that would allow the conditioned or unconditioned air in the duct 10 to enter the interior space through a vent (not shown) in wall 24. The duct 10 can extend through the top sill 29 and further extend through the space between the top sill 29 and upper floor 31 of a two-story structure. In other words, the inventive duct in this example is used in both a wall space and a floor space. However, the inventive duct can be used in any interior space or combination of spaces of a structure, wherein insulation from heat or cold conditions is not required. The inventive duct can be configured in terms of its positioning in the interior spaces of a given structure in any known way.

For purposes of the invention, uninsulated means that the inventive duct does not use any insulating material surrounding the fire resistant barrier layer. While the fire resistant barrier layer as part of the inventive duct may technically have some finite insulating value, the duct is effectively one that is non-insulating as there is no other insulating material associated with the duct. The insulating value of the fire resistant barrier layer is negligible such that a duct that is solely made up of the polymer core and the fire resistant barrier layer is effectively one that does not provide an effective insulating value.

The fire resistant barrier layer can be any material that would provide the required UL 181 Class 1 flame spreading and smoke development resistance, as part of its surrounding of the polymer core. The materials of the fire resistant barrier layer include woven and nonwoven materials, including fiberglass-containing materials, materials that use Nomex fibers, materials that use Nomex fibers in combination with other fibers, materials that may contain ceramic coated fibers/yarns, and the like.

One example of the material that can be used as the fire resistant barrier layer is a fire resistant fleece as disclosed in U.S. Pat. No. 10,443,190 to Wenstrup, which is incorporated in its entirety herein. This fleece includes a fire resistant (FR) fiber, which is defined to be fibers having a limiting oxygen index (LOI) value of 20.95 or greater as determined by ISO 4589-1. The Wenstrup patent provides different examples of these kinds of fibers, e.g., FR resistant rayon staple fibers wherein these fibers are between 20-80% of the weight of the fleece. The fleece also preferably includes a plurality of char scaffold fibers, which are defined as fibers once burned retaining a portion (at least 80%) of their original strength. Examples of these include mineral fibers such as silica and basalt, aramids, carbon fibers, partially oxidized polyacrylonitride (PAN) and fully carbonized fibers, with the weight percentage of these preferable fibers similar to the FR fibers, i.e., between 20-80% by weight. The fire resistant fleece can also incorporate a scrim as a part thereof and include other non-fire resistant fibers, e.g., polyester fibers, up to a certain weight percentage that does not comprise the fire resistant properties of the fleece.

It is also believed that the fiberglass fabric used in the S-TL duct described above is also a candidate for the fire resistant barrier layer of the inventive duct. High-Temp Suntex textiles also provide a number of different materials, e.g., fire resistant fiberglass fabric, high temperature fiberglass cloths, and woven fiberglass cloths that are believed to be suitable candidates as the fire resistant barrier layer of the inventive duct, see https://www.coatedfiberglassfabric.com/supplier-307158-fire-resistant-fiberglass-fabric, https://www.coatedfiberglassfabric.com/supplier-305933-high-temperature-fiberglass-cloth, and https://www.coatedfiberglassfabric.com/supplier-305861-woven-fiberglass-cloth. Fiberglast also makes woven and nonwoven fiberglass fabrics that are believed to be suitable for use as the fire resistant barrier layer, see https://www.fibreglast.com. Fiberglass-containing fabrics made by Milliken of Spartanburg, South Carolina are also candidates for the fire resistant barrier layer.

The fire resistant barrier layer can have a variety of thicknesses. However, it is preferred that the thickness of the fire resistant barrier layer be kept to just a thickness that would meet the UL 181 Class 1 duct standard rating. Keeping the fire resistant barrier layer to a minimal thickness while still meeting the UL 181 Class 1 duct standard rating reduces the amount of material need to surround the polymer core and keeps costs down. It also provides an overall smaller duct diameter, which facilitates the use of the duct in wall spaces or floor spaces when being used to move conditioned or unconditioned air. Preferably, the fire resistant barrier layer is less than an inch in thickness so that the compressibility of the polymer core is not compromised and the overall diameter of the uninsulated duct does not interfere with its installation in a given interior space.

For felt/fabric type materials, typical thicknesses of these kinds of materials range from 4 to 200 mils (0.004 to 0.2 inches) with a more preferred thickness of 20 to 200 mils (0.02 to 0.2 inches).

The fire resistant barrier layer can be associated with the polymer core in any known fashion. Examples of associations include the use of an adhesive to adhere the inner surface of the fire resistant barrier layer to the outer surface of the polymer core. FIG. 3 shows a schematic of a sectional view of a longitudinal portion of the uninsulsated duct 10 with an adhesive layer 31 disposed between the polymer core 1, containing the wire helix 33, and the fire resistant barrier layer 7.

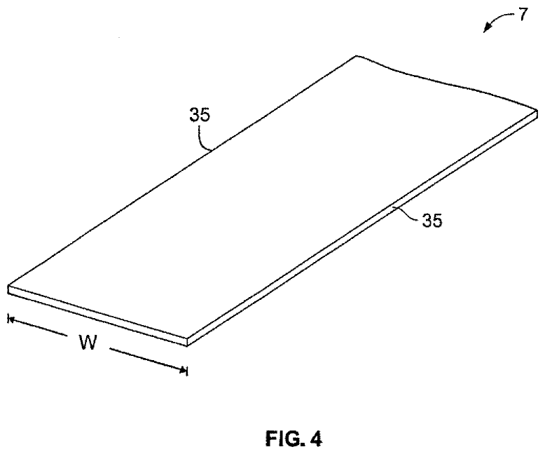

Referring now to FIG. 4, when associating the fire resistant barrier layer with the polymer core, the fire resistant barrier layer 7 is provided or cut to a given width W so as to form opposing longitudinal edges 35, wherein the W corresponds generally to the outer perimeter of the polymer core. The fire resistant barrier layer is wrapped around the polymer core so that the opposing edges either meet or overlap, preferably overlap, to ensure coverage of the polymer core, with one another. As part of the wrapping, an adhesive can be used as described above so that the fire resistant barrier layer is adhered to the polymer core outer surface. Alternatively, the opposing edges 35 can be sewn or stitched together in a manner so that the fire resistant barrier layer is firmly positioned around the polymer core and not susceptible to any significant movement along a length of the polymer core that would disrupt the composite construction and fire rating of the duct. FIG. 1 shows an example of overlapped edges of the fire resistant barrier layer 7 that is stitched together at 37.

Mechanical means could also be employed, e.g., clamps, straps, zip ties, wherein the mechanical attachment is such that the fire resistant barrier layer is held in place when positioned against the outer surface of the polymer core. Combinations of attachment techniques described above are also within the scope of the invention.

The manner of association between the polymer core and fire resistant barrier layer can be accomplished in a batch or continuous method. In a batch method, a given length of polymer core and fire resistant barrier layer are provided and the two are associated together using one of the techniques described above.

In a continuous method, the fire resistant barrier layer could be continually fed along side a moving polymer core, wherein the appropriate machinery could wrap the fire resistant barrier layer around polymer core. A means could be additionally provided for the continuous use of an adhesive or stitching to associate the fire resistant barrier layer with the polymer core and produce the flexible uninsulated inventive duct. The manufactured duct could then be cut to a desired length or a stock length, which could be shortened later for a given application.

Typical duct dimensions can range from 2 to 20 inches, which is the range of available sizes for the prior art S-TL duct. However, for the use of the uninsulated duct in interior spaces, smaller sizes are preferred, e.g., less than 8-10 inches, less than 6 inches, less than 4.5 inches in diameter, and even 15 inches or less in diameter. The uninsulated duct could come in virtually any length that a particular application would require, similar to the S-TL duct, whose length as a duct is not limited.

As such, an invention has been disclosed in terms of preferred embodiments thereof which fulfills each and every one of the objects of the present invention as set forth above and provides a new and improved uninsulated duct for use in supplying conditioned or unconditioned air to an interior space that does not require additional insulation for the duct and a method of use.

Of course, various changes, modifications and alterations from the teachings of the present invention may be contemplated by those skilled in the art without departing from the intended spirit and scope thereof. It is intended that the present invention only be limited by the terms of the appended claims.

I claim:

1. A flexible uninsulated duct that meets Underwriter Laboratories (UL) 181 Class 1 duct standard comprising:
a polymer core having a helical wire as a part thereof, the polymer core forming an inner space for conditioned air flow, and having an outer surface; and
a fire resistant barrier layer surrounding the outer surface of the polymer core, a first surface of the fire resistant barrier layer facing the outer surface of the polymer core and an outer surface of the fire resistant barrier layer exposed to form an outer surface of the uninsulated duct, the fire resistant barrier layer providing flame spreading and smoke development resistance such that the flexible uninsulated duct meets the UL 181 Class 1 duct standard.

2. The flexible uninsulated duct of claim 1, wherein the polymer core further comprises a pair of PET layers with a helical wire positioned therebetween.

3. The flexible uninsulated duct of claim 1, wherein a length of the uninsulated duct is more than 14 feet in length.

4. The flexible uninsulated duct of claim 1, wherein the fire resistant barrier layer is adhered to the outer surface of the polymer core using an adhesive.

5. The flexible uninsulated duct of claim 1, wherein the fire resistant barrier layer has first and second opposing longitudinal edges, the first and second opposing longitudinal edges sewn together such that the fire resistant barrier layer surrounds the outer surface of the polymer core.

6. The flexible uninsulated duct of claim 1, wherein the fire resistant barrier layer is a woven or nonwoven fabric material containing fiberglass.

7. The flexible uninsulated duct of claim 1, wherein the fire resistant barrier layer comprises a fire resistant fleece, the fire resistant fleece including fire resistant staple fibers and, optionally, char scaffold fibers.

8. In a method of moving conditioned or unconditioned air through a flexible uninsulated duct in an interior space of a structure, wherein the flexible uninsulated duct meets UL 181 Class 1 duct standard, the improvement comprising providing one or more of the flexible uninsulated duct of claim 1 in the interior space.

9. The method of claim 8, wherein the one or more flexible uninsulated duct is positioned in a wall or floor space as the interior space in the structure.
